(19) United States
(12) Patent Application Publication
(10) Pub. No.: US 2009/0083744 A1
(43) Pub. Date: Mar. 26, 2009

(54) INFORMATION WRITING/READING SYSTEM, METHOD AND PROGRAM

(75) Inventor: MASAO SHIMADA, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/238,344

(22) Filed: Sep. 25, 2008

(30) Foreign Application Priority Data
Sep. 26, 2007 (JP) 2007-250057

(51) Int. Cl. G06F 9/46

(52) U.S. Cl. 718/102

(57) ABSTRACT

An information writing/reading system includes a thread scheduler unit configured to control a sequence of execution for a plurality of threads, a thread execution unit, a device driver unit configured, a disk mechanism, an end time estimation unit configured to estimate an end time of execution of an issued write command, and a command management unit, wherein the thread scheduler unit is configured to temporarily suspend execution of at least one read thread of the plurality of threads if the command management unit determines that an estimated end time of execution of the issued write command is greater than an end time designated by the issued write command.

This application is based upon and claims the benefit of priority from Japanese patent application No. 2007-250057, filed on Sep. 26, 2007, the disclosure of which is incorporated herein in its entirety by reference.

### BACKGROUND

1. Technical Field

Aspects of the present invention relate to an information recording/reproducing system, an information recording/reproducing method and an information recording/reproducing program, for reading and writing data from and to a recording medium such as a hard disk.

2. Description of the Related Art

An information recording/reproducing system for recording and reproducing information using a hard disk drive or the like involves mechanical actuation in an information reading and writing process. Since the processing speed of a drive system that is responsible for the mechanical actuation is significantly slower than the CPU processing speed of an arithmetic control system that is responsible for the arithmetic, such as command processing, the system response may possibly be unbalanced. For example, the command from the arithmetic control system to the drive system may be stagnated.

Therefore, in a typical information recording/reproducing system, various contrivances are employed to compensate for a difference in the processing speed between the drive system and the arithmetic control system to read or write a large volume of information from or to the hard disk drive or the like. In this connection, an apparatus as disclosed in Japanese Patent Laid-Open No. 2000-181853 (hereinafter “Patent Document 1”) has a means for monitoring the elapsed time for each command after storing a read/write command in the control device, and promptly issuing a command to the disk device, which is not issued to the disk device even after a predetermined time has passed.

However, the apparatus as disclosed in Patent Document 1 only deals with a delay in the command processing after it occurs and there is a risk of overflow of a buffer that temporarily stores write data if the write (writing) command processing is stagnated, which imposes a problem that if a buffer overflow occurs, write data is lost. If the lost data is video data, it is likely that 1 GOP (Group of Picture) of data including this lost data can not be reproduced, which is a significant problem.

### SUMMARY

An exemplary aspect of the present invention is to solve the above-mentioned problems with the related art, and to provide an information recording/reproducing system for avoiding loss of write data caused by a buffer overflow due to the stagnation of the write command processing. Exemplary embodiments of the present invention also overcome disadvantages not described above and the present invention is not required to overcome the disadvantages described above. Indeed, exemplary embodiments of the present invention may not overcome any of the problems described above.

An exemplary aspect of the invention concerning an information recording/reproducing system includes a thread scheduler unit configured to control a sequence of execution for a plurality of threads, a thread execution unit configured to invoke and execute a write thread or a read thread, a device driver unit configured to issue a write command or a read command corresponding to the thread executed by the thread execution unit, a disk mechanism configured to record and reproduce information in accordance with each command, an end time estimation unit configured to estimate an end time of execution of the issued write command, and a command management unit configured to determine whether or not the estimated end time of execution is greater than an end time designated by command, wherein the thread scheduler unit temporarily suspends execution of at least one read thread of the plurality of threads if it is determined that the estimated end time of execution is greater than the end time designated by command.

Also, an exemplary aspect of the invention concerning an information recording/reproducing method includes a thread scheduling operation of controlling an sequence of execution for a plurality of threads, a thread execution operation of invoking and executing a write thread or read thread, a command issuance operation of issuing a write command or a read command corresponding to the thread executed at the thread execution operation, an information recording/reproducing operation of recording and reproducing information by controlling a disk mechanism in accordance with the issued command, an end time estimation operation of estimating an end time of execution of the issued write command, a determination operation of determining whether or not the end time of execution estimated at the end time estimation operation is greater than an end time designated by command; and a reading limitation operation of temporarily suspending execution of at least one read thread among the plurality of threads if it is determined that the estimated end time of execution is greater than the end time designated by command.

Also, an exemplary aspect of the invention concerning an information recording/reproducing program run on a computer, includes a thread scheduling process to control an sequence of execution for a plurality of threads, a thread execution process to invoke and execute a write thread or read thread in accordance with a sequence, a command issuance process to issue a write command or a read command corresponding to the execution of the thread, an information recording/reproducing process to record and reproduce information by controlling a disk mechanism in accordance with each command, an end time estimation process to calculate the estimated value of the end time of execution of the issued write command, a determination process to determine whether or not the estimated end time of execution calculated at the end time estimation process is greater than the end time designated by command; and a reading limitation process to temporarily suspend execution of at least one read thread among the plurality of threads if it is determined at the determination process that the estimated end time of execution is greater than the end time designated by command.

### BRIEF DESCRIPTION OF THE DRAWINGS

The aspects of the present invention will become more apparent by describing in detail exemplary embodiments thereof with reference to the accompanying drawings, in which:

FIG. 1 is a block diagram showing the configuration of an information recording/reproducing system according to exemplary embodiment of the present invention.

FIG. 2 is a flowchart showing the operation of an information recording/reproducing system according to an exemplary embodiment of the present invention.

FIG. 3 is a diagram showing an example of a command stored in the command management unit of an exemplary embodiment of the present invention.

FIG. 4 is a diagram showing the track sector position information stored in the recording/reproducing device information storage unit of an exemplary embodiment of the present invention.

FIG. 5 is a diagram showing a recording/reproducing device information stored in the recording/reproducing device information storage unit of an exemplary embodiment of the present invention.

FIG. 6 is a flowchart showing the operation for estimating the end time of the write command in the recording/reproducing device of an exemplary embodiment of the present invention.

FIG. 7 is a flowchart showing the operation of the device driver unit to notify the read thread number to the thread scheduler of an exemplary embodiment of the present invention.

FIG. 8 is a flowchart showing the arithmetic of the thread scheduler unit according to an exemplary embodiment of the present invention.

FIG. 9 is a diagram showing an example of a system call that the AP thread unit sends to the device driver unit according to an exemplary embodiment of the present invention.

### DESCRIPTION OF EXEMPLARY EMBODIMENTS

Hereinafter, exemplary embodiments of the present invention are described with reference to the drawings.

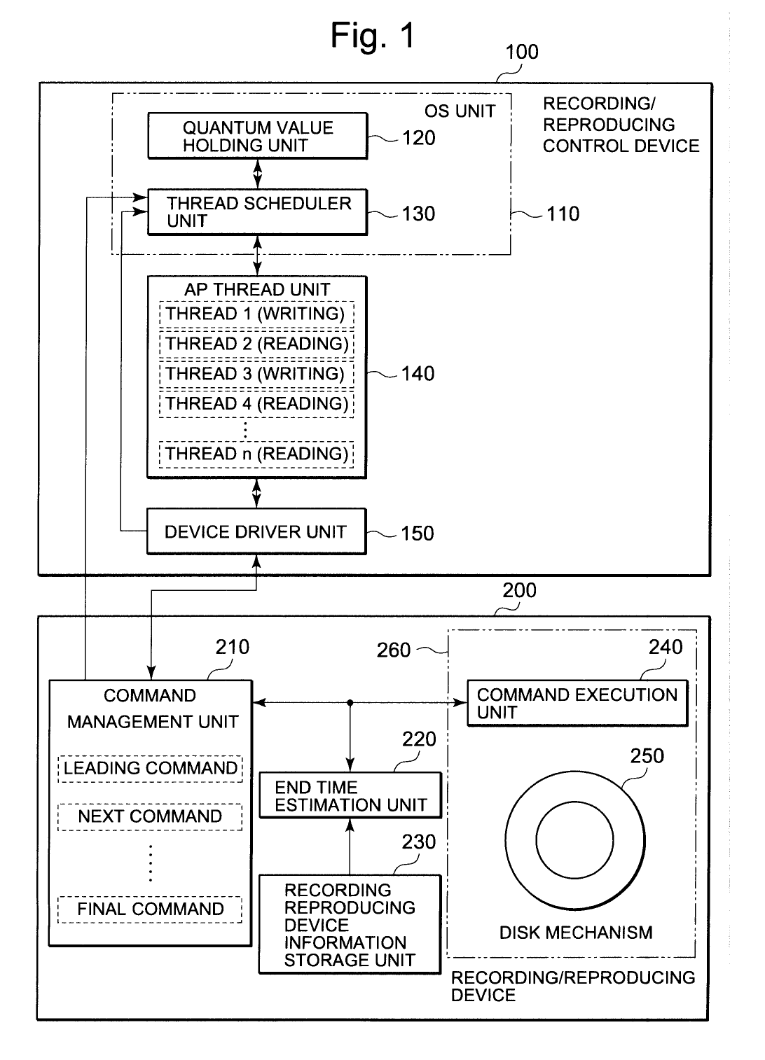

FIG. 1 is a block diagram showing the configuration of an information recording/reproducing system according to an exemplary embodiment of the present invention. The information recording/reproducing system according to this embodiment comprises a recording/reproducing control device 100 that outputs a write command (writing command) or read command (reading command) and a recording/reproducing device 200 that receives the write command or read command and records or reproduces information in accordance with the command.

The recording/reproducing control device 100 comprises an OS (Operating System) unit 110 that controls information recording/reproducing process of the recording/reproducing device 200, an AP thread unit 140 as a thread execution unit that retains a plurality of threads generated by execution of an application and executes each of the threads, and a device driver unit 150 that issues a command to the recording/reproducing device 200 in accordance with the thread executed by the AP thread unit 140 and sends or receives the write data and read data corresponding to each command to or from the recording/reproducing device 200. Here, the term “thread” may mean, for example, an execution unit of software, but is not limited to this meaning. In the application software that performs high level processing, a plurality of processes are executed in parallel by running a plurality of threads. Thereby, it is possible to accept data input by an operation of user during arithmetic processing.

The recording/reproducing device 200 comprises a command management unit 210 that receives a write/read command from the recording/reproducing control device 100, an end time estimation unit 220 that estimates an end time of execution of an issued write command, a recording/reproducing device information storage unit 230 that stores information such as specifications of the recording/reproducing device 200, and a disk mechanism 260 that performs reading and writing of information. The disk mechanism 260 comprises a disk 250 that is a storage medium, and a command execution unit 240 that has an arm, head or the like for reading or writing data from or to the disk 250, and controls the driving thereof in accordance with an input command.

The OS unit 110 in the recording/reproducing control device 100 comprises a quantum value holding unit 120 and a thread scheduler unit 130. The quantum value holding unit 120 holds an initial quantum value and a real time quantum value for each thread. The term “quantum value” may mean, for example, a value indicating an executable time of a thread within a scheduling interval time (epoch), but this term is not limited to this definition. The quantum value of a thread being executed is counted down from the initial value at every unit of time, and if the quantum value reaches zero, then the thread is not to be executed within the particular epoch.

The thread scheduler unit 130 instructs the AP thread unit 140 to start/stop the thread based on a priority and a quantum value of the thread, controls a sequence of execution of a plurality of threads, and changes the setting of a quantum value of the quantum value holding unit 120. The thread is associated with a priority, and the thread scheduler unit 130 selects the thread using the associated priority, for example, in descending order of priority, and instructs the execution of the thread. If another thread having a higher priority than a thread being executed becomes on standby during execution of the thread, the other thread having higher priority is executed, even if the quantum value of the thread being executed remains. If such an interruption does not occur, then the thread is continuously executed until the quantum value reaches zero.

The AP thread unit 140 retains a plurality of write threads (writing threads) or read threads (reading threads), invokes and executes threads in accordance with an instruction from the thread scheduler unit 130 and sends a write/read system call to the device driver unit 150.

The device driver unit 150 receives the write/read system call from the AP thread unit 140 and issues a write command or read command based on the received write/read system call. Further, the device driver unit 150 sends write data together with the write command and receives read data corresponding to the read command. Moreover, the device driver unit 150 sends the corresponding thread number to the thread scheduler unit 130 when receiving the read system call.

The command management unit 210 in the recording/reproducing device 200 holds a plurality of write/read commands from the recording/reproducing control device 100 in a state where the write/read commands are sorted according to a sequence of execution. The command management unit 210 sends write data together with the write/read command to the command execution unit 240 and receives read data to transfer the read data to the recording/reproducing control device 100. Further, the command management unit 210 sends the write command also to the end time estimation unit 220, receives the estimated end time of execution of the command, which is calculated by the end time estimation unit 220, and determines whether or not the estimated end time of execution is greater than the end time designated by the write command. If the estimated end time of execution of the command is greater than the end time designated by command, then the command management unit 210 sends a notification of recording crisis to the thread scheduler unit 130.

The end time estimation unit 220 receives the write command from the command management unit 210, acquires information about recording/reproducing device 200 (hereinafter, referenced as “recording/reproducing device information”) from the recording/reproducing device information storage unit 230, and acquires information about a current position of a head (hereinafter, referenced as “head position information”) from the command execution unit 240. And the end time, the estimation unit 220 calculates the estimated value of the end time of execution of the received write command based on the current head position information and the recording/reproducing device information.

The recording/reproducing device information storage unit 230 stores the specifications of the disk mechanism 260 and the current status of the disk mechanism 260 as recording/reproducing device information and sends the recording/reproducing device information upon accepting an instruction from the end time estimation unit 220. The recording/reproducing device information may include, but is not limited to, a track jump speed, a disk rotation speed, a full stroke seek time and a current head position, for example.

The command execution unit 240 receives the write/read command from the command management unit 210, and writes write data to the disk 250, or reads read data from the disk 250 to send the read data to the recording/reproducing control device 100 via the command management unit 210. Further, the command execution unit 240 sends the current head position information to the end time estimation unit 220.

Also, the thread scheduler unit 130 temporarily suspends the execution of all or part of the read threads when receiving the notification of recording crisis from the command management unit 210. Specifically, the thread scheduler unit 130 reduces the quantum value assigned to the read thread at the time of receiving the notification of recording crisis, or lowers the priority of each read thread when receiving the notification of recording crisis. In this way, the write thread can be given priority for being executed, by postponing the sequence of execution of the read thread, and the stagnation of the write command processing can be mitigated.

By way of example, the thread scheduler unit 130, the AP thread unit 140, the device driver unit 150, the command management unit 210, and the end time estimation unit 220 may be realized by a program executed on a computer.

The operation of another exemplary embodiment will be described below. An exemplary method for recording/reproducing information will also be described below by describing each operation of the method.

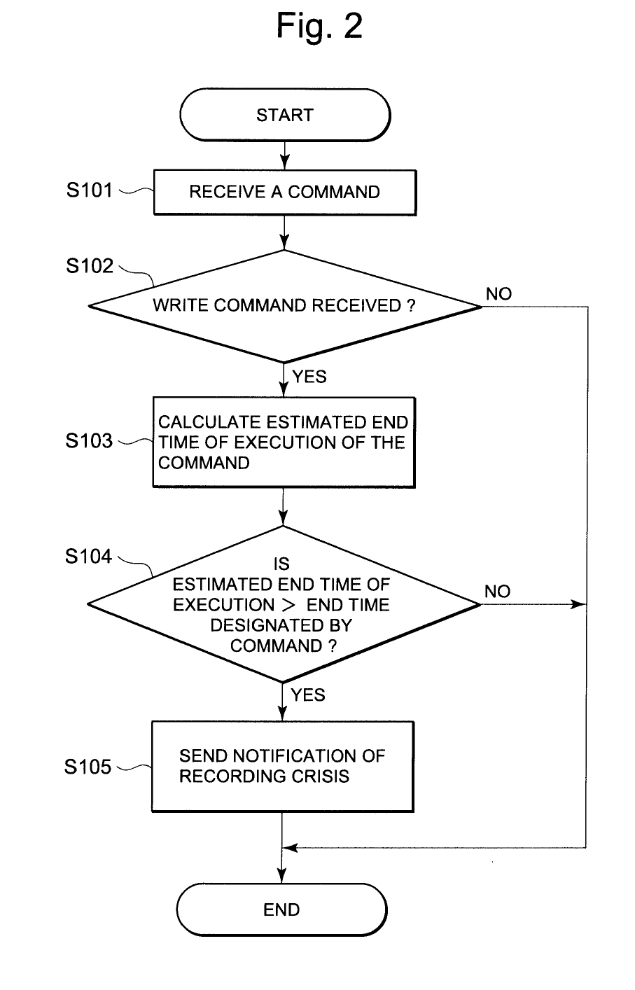

FIG. 2 is a flowchart showing the operation of the recording/reproducing device 200 according to an exemplary embodiment of the present invention.

As shown in FIG. 2, in the recording/reproducing device 200, first the command management unit 210 receives a write/read command (FIG. 2: operation S101), and determines whether or not a write command has been received (FIG. 2: operation S102). If it is determined that a write command has not been received (NO in operation S102), then the operation of the recording/reproducing device 200 shown in FIG. 2 is ended. If it is determined that a write command has been received (YES in operation S102), then the end time estimation unit 220 calculates the estimated end time of execution of the received write command (FIG. 2: operation S103, end time of execution estimation operation).

The command management unit 210 determines whether or not the estimated end time of execution, which is calculated by the end time estimation unit 220, is greater than the end time designated by the received write command (FIG. 2: operation S104, determination operation). If it is determined that the estimated end time of execution is not greater than the end time designated by the received write command (NO in operation S104), then the operation of the recording/reproducing device 200 shown in FIG. 2 is ended. If it is determined that the estimated end time of execution is greater than the end time designated by the received write command (YES in operation S104), then the command management unit 210 sends the notification of recording crisis to the thread scheduler unit 130 (FIG. 2: operation S105).

The end time designated by the received write command is held as a designated end time in a command packet. This designated end time is calculated by the AP thread unit 140, and a write command system call including the designated end time is sent to the device driver unit 150. The device driver unit 150 sends this designated end time included in the command packet to the command management unit 210.

The estimated end time of execution and the end time designated by a received write command may indicate the elapsed time from a certain point of time in the past with high accuracy (e.g. to the order of microseconds) with data of enough bits to provide Such accuracy. Further, the, estimated end time of execution and the end time designated by a received write command may increase according to the passage of time.

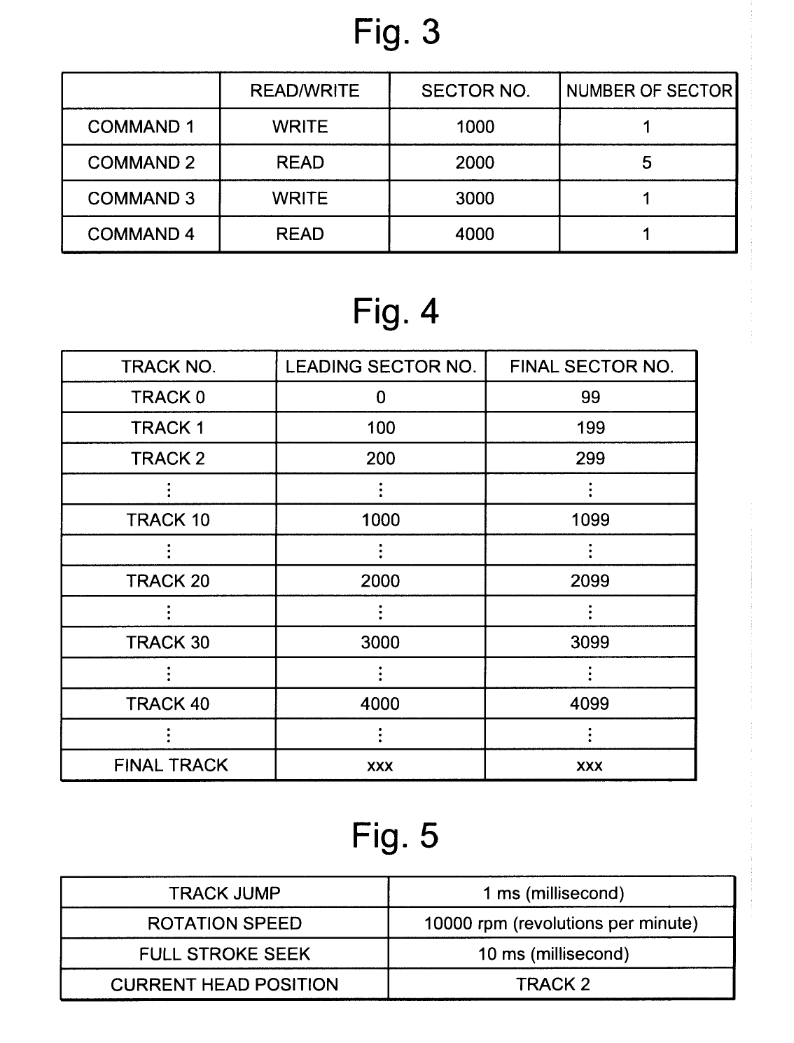

FIG. 3 is a diagram showing examples of commands stored in the command management unit 210 according to an exemplary embodiment of the present invention. In the example shown in FIG. 3, the commands 1 to 4 are stored in the sequence of execution. FIG. 3 indicates, as an example, that the command 1 is to write one sector from sector 1000, the command 2 is to read five sectors from sector 2000, the command 3 is to write one sector from sector 3000, and the command 4 is to read one sector from sector 4000.

FIG. 4 is a diagram showing an example of the track information of the disk 250 held by the recording/reproducing device information storage unit 230 according to an exemplary embodiment of the present invention. FIG. 4 indicates an example of the range of sectors included in each track of the disk 250, in which the track 0 ranges from sector 0 to sector 99, the track 1 ranges from sector 100 to sector 199, the track 2 ranges from sector 200 to sector 299, and the other tracks have similar ranges. However, the example of the track information of the disk 250 that is shown in FIG. 4 is merely illustrative in nature and many variations of track information of the disk 250 may be employed consistent with the present invention.

FIG. 5 is a diagram showing an example of data held by the recording/reproducing device information storage unit 230 according to an exemplary embodiment of the present invention. The recording/reproducing device information storage unit 230 holds the specifications of the recording/reproducing device 200 and the current state of the drive. FIG. 5 shows an example wherein the track jump is 1 millisecond, the disk rotation speed is 10000 rpm (revolutions per minute), the full stroke seek is 10 milliseconds, and the current head position is located on track 2, however, the example of the data held by the recording/reproducing device information storage unit 230 that is shown in FIG. 5 is merely illustrative in nature and many variations of data may be held by the recording/reproducing device information storage unit 230 consistent with the present invention.

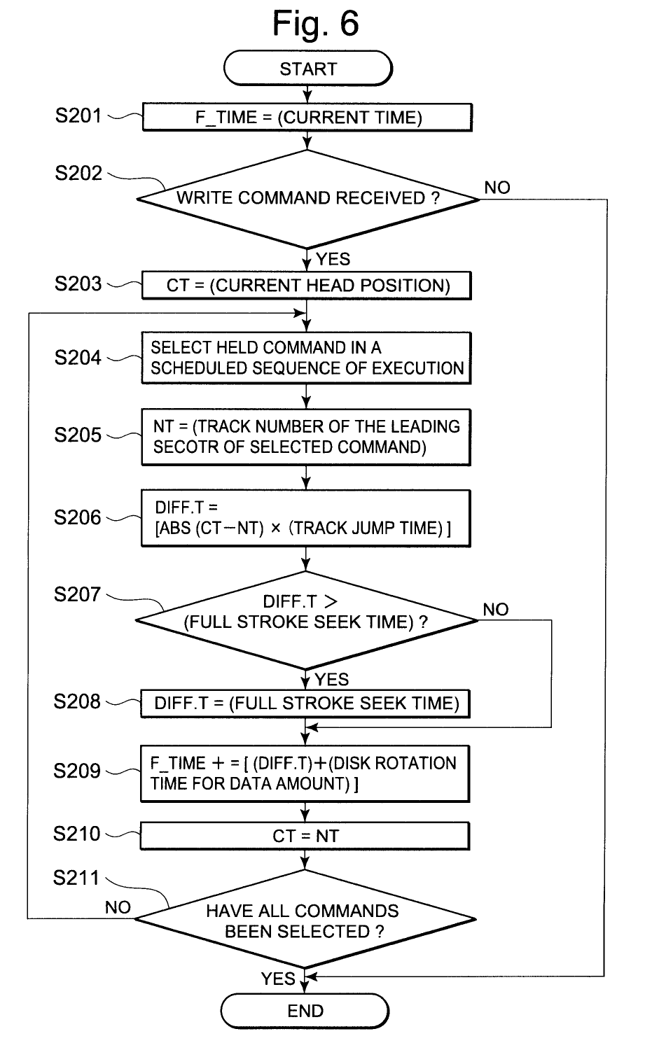

FIG. 6 is a flowchart showing an operation for calculating the estimated end time of execution of the write command in the end time estimation unit 220 according to an exemplary embodiment of the present invention, and shows details of operation S103 in FIG. 2 as described above.

First of all, the current time is set to F_Time (estimated end time of execution) (FIG. 6: operation S201). Next, it is determined whether or not the command received by the command management unit 210 is a write command (FIG. 6: operation S202). If it is determined that the received command is not a write command (NO in operation S202), then the operation for calculating the estimated end time of execution of the write command is ended. If it is determined that the received command is a write command (YES in operation S202), then the track number that corresponds to the current head position is set to CT (Current Track) (FIG. 6: operation S203).

Subsequently, the command held in the command management unit 210 is selected in a scheduled sequence of execution (FIG. 6: operation S204). The track number of the first sector indicated in the selected command is set to NT (Next Track) (FIG. 6: operation S205), and the absolute value of a difference between CT and NT multiplied by the track jump time is set to Diff.T (Difference Time) (FIG. 6: operation S206).

Subsequently, it is determined whether or not this Diff.T is greater than the full stroke seek time (FIG. 6: operation S207). If it is determined that Diff.T is greater than the full stroke seek time (YES in operation S207), then the setting of Diff.T is changed to the full stroke seek time (FIG. 6: operation S208). And, the value of adding Diff.T and the disk rotation time for data amount to an existing F_Time is calculated as a new F_Time (i.e., F_Time+=[(Diff.T)+(DISK ROTATION TIME FOR DATA AMOUNT)] (FIG. 6: operation S209).

The value of NT is set to the value of CT (FIG. 6: operation S210). It is determined whether or not all of the commands held in the command management unit 210 have been selected (FIG. 6: operation S211). If it is determined that all of the commands have been selected (YES in operation S211), then the operation for calculating the estimated end time of execution of the write command is ended. If it is determined that any of the commands have not been selected (NO in operation S211), then a command is selected in sequence again (FIG. 6: operation S204).

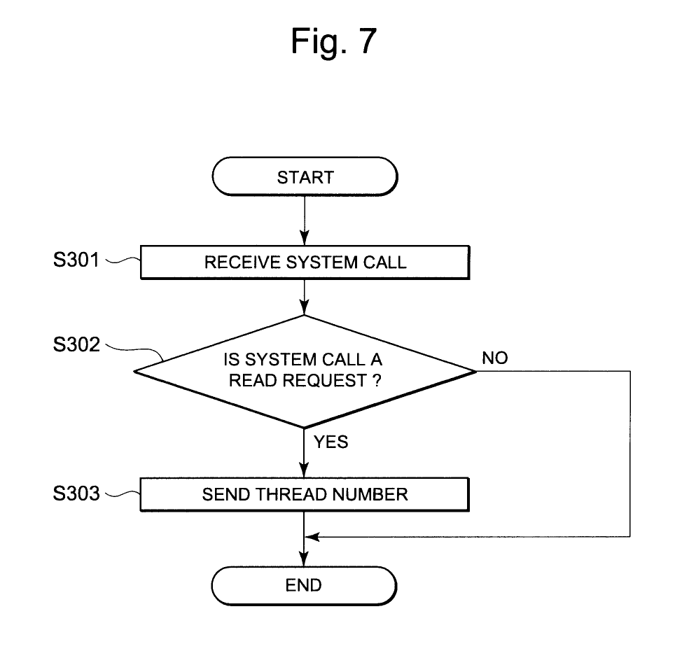

FIG. 7 is a flowchart showing an operation of the device driver unit 150 to notify the thread scheduler unit 130 of the read thread number according to an exemplary embodiment of the present invention.

First of all, the device driver unit 150 receives a system call from the AP thread unit 140 (FIG. 7: operation S301), and determines whether or not the system call is a read request (FIG. 7: operation S302). If it is determined that the system call is not a read request (NO in operation S302), then the operation of the device driver unit 150 to notify the thread scheduler unit 130 of the read thread number is ended. If it is determined that the system call is a read request (YES in operation S302), then the thread number included in the system call is sent to the thread scheduler unit 130 (FIG. 7: operation S303), and the operation of the device driver unit 150 to notify the thread scheduler unit 130 of the read thread number is ended.

Thereby, the thread scheduler unit 130 can select the read thread from a plurality of threads held in the AP thread unit 140, based on the thread number notified from the device driver unit 150.

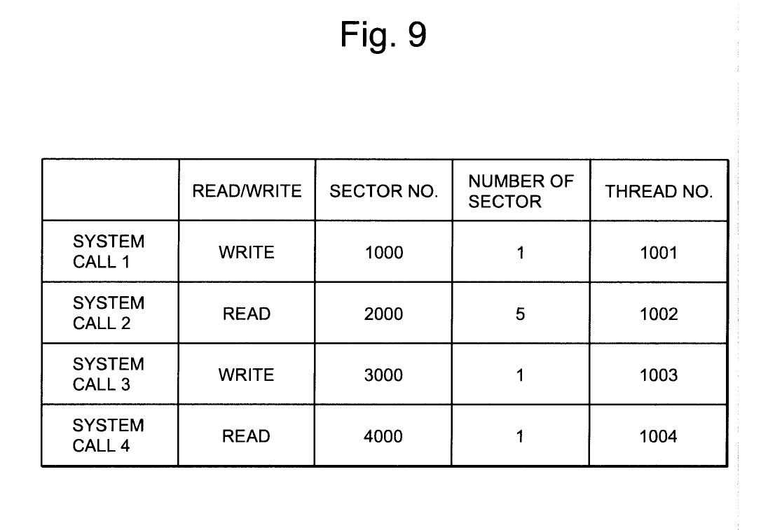

FIG. 9 is a diagram showing an example of a system call that is sent by the AP thread unit 140 and received by the device driver unit 150 according to an exemplary embodiment of the present invention.

According to the example shown in FIG. 9, the system call 1 indicates that the thread of thread number 1001 issues a write system call of one sector from sector 1000, the system call 2 indicates that the thread of thread number 1002 issues a read system call of five sectors from sector 2000, the system call 3 indicates that the thread of thread number 1003 issues a write system call of one sector from sector 3000, and the system call 4 indicates that the thread of thread number 1004 issues a read system call of one sector from sector 4000.

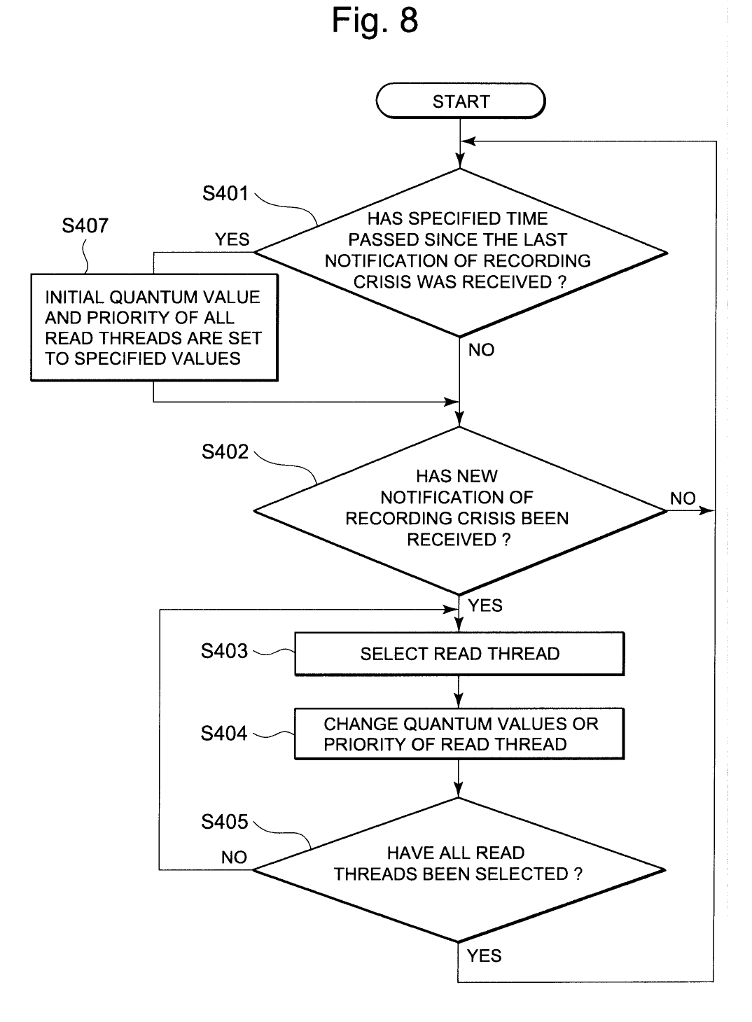

FIG. 8 is a flowchart showing the operation of the thread scheduler unit 130.

First, the thread scheduler unit 130 determines whether or not a specified time has passed since the last notification of recording crisis was received (FIG. 8: operation S401). If it is determined that the specified time has passed (YES in operation S401), then the initial quantum value and priority of all of the read threads are set to specified values (FIG. 8: operation S407). Subsequently, it is determined whether or not a new notification of recording crisis has been received (FIG. 8: operation S402). If it is determined that a new notification of recording crisis has been received (YES in operation S402), then the read thread is selected based on the thread number notified from the device driver unit 150 (FIG. 8: operation S403). The current quantum value and the initial quantum value of the selected read thread are set to 0 and the information within the quantum value holding unit 120 is updated, or the priority of the selected read thread is decreased (FIG. 8: operation S404, reading limitation operation). It is determined whether or not all of the read threads have been selected (FIG. 8: operation S405). If it is determined that all of the read threads have been selected (YES in operation S405), then it is determined again whether or not the specified time has passed since the last notification of recording crisis was received (FIG. 8: operation S401). If it is determined that the specified time has passed (YES in operation S401), then the initial quantum value and priority of all of the read threads are set to the specified values (FIG. 8: operation S407).

For example, the thread scheduler unit 130 sets the initial quantum value to a quantum value indicating the executable time of each thread within the epoch for every scheduling interval time (epoch). The quantum value is decreased while the thread is selected and operating. If the quantum value reaches zero, then the thread is not selected during the same epoch period. In this way, the quantum value indicates the executable time of the thread within an epoch.

On the other hand, the thread scheduler unit 130 selects the thread to be executed in accordance with priority and instructs the execution of the thread. A priority is set for each thread, wherein the thread scheduler unit 130 selects the thread in descending order of priority. If another thread having higher priority than a thread being executed becomes on standby during execution of the thread, then the thread being executed is put on standby, and the other thread having higher priority is executed, even if the quantum value of the thread being executed remains. If such an interruption by a higher priority thread does not occur, then the thread being executed is continuously executed until the quantum value reaches zero.

Hence, according to exemplary information recording/reproducing systems of the present invention, the end time of the write command processing is estimated by the end time estimation unit 220. If the command management unit 210 determines that the estimated end time of execution is beyond the end time designated by the write command, then the thread scheduler unit 130 lowers the priority of the read thread, or reduces the quantum value of the read thread at that time. Therefore, the resource allocation within the system can be concentrated on the write process by temporarily suspending the execution of the read thread, so that the sufficient write speed can be attained. Hence, among other advantages, it is possible to avoid overflow of a buffer for the write data caused by the stagnation of the write command processing and, consequently, avoid loss of write data due to the overflow of buffer.

While exemplary embodiment of the present invention have been described in detail above, it is contemplated that numerous modifications may be made to the above exemplary embodiments without departing from the spirit and scope of the embodiments of the present invention as defined in the following claims.

What is claimed is:

1. An information writing/reading system comprising:
a thread scheduler unit configured to control a sequence of execution for a plurality of threads;
a thread execution unit configured to execute a write thread and a read thread;
a device driver unit configured to issue at least one of a write command and a read command corresponding to the write thread and the read thread;
a disk mechanism configured to write and read information in accordance with the at least one of a write command and a read command;
an end time estimation unit configured to estimate an end time of execution of an issued write command; and
a command management unit configured to determine whether or not the estimated end time of execution of the issued write command is greater than an end time designated by the issued write command;
wherein the thread scheduler unit is configured to temporarily suspend execution of at least one read thread of the plurality of threads if the command management unit determines that the estimated end time of execution of the issued write command is greater than the end time designated by the issued write command.

2. The information writing/reading system according to claim 1, wherein the thread scheduler unit is configured to select a thread to be executed in accordance with a priority set for each of the plurality of threads, and
wherein the thread scheduler unit is configured to lower the priority of the read thread if the command management unit determines that the estimated end time of execution of the issued write command is greater than the end time designated by the issued write command.

3. The information writing/reading system according to claim 1, wherein the thread scheduler unit is configured to reduce a quantum value assigned to the read thread if the command management unit determines that the estimated end time of execution of the issued write command is greater than the end time designated by the issued write command, and
wherein the quantum value indicates an executable time of the read thread.

4. The information writing/reading system according to claim 1, wherein the end time estimation unit is configured to estimate the end time of execution of the issued write command using a status of the disk mechanism.

5. The information writing/reading system according to claim 1, wherein the device driver unit is configured to send to the thread scheduler unit a thread number corresponding to the read thread if the read thread is executed by the thread execution unit, and
wherein the thread scheduler unit is configured to select at least one read thread from the plurality of threads using the thread number and to temporarily suspend execution of the selected read thread, if the command management unit determines that the estimated end time of execution of the issued write command is greater than the end time designated by the issued write command.

6. The information writing/reading system according to claim 1, wherein the command management unit is configured to send a notification of a recording problem to the thread scheduler unit.

7. The information writing/reading system according to claim 6, wherein the thread scheduler unit is configured to select a thread to be executed in accordance with a priority set for each of the plurality of threads, and to lower a priority of a read thread if the notification of a recording problem is received.

8. The information writing/reading system according to claim 6, wherein the thread scheduler unit is configured to reduce a quantum value assigned to the read thread it the notification of a recording problem is received, and
wherein the quantum value indicates an executable time of the read thread.

9. The information writing/reading system according to claim 6, wherein the device driver unit is configured to send to the thread scheduler unit a thread number corresponding to the read thread if the read thread is executed by the thread execution unit, and
wherein the thread scheduler unit is configured to select at least one read thread from the plurality of threads using the thread number and to temporarily suspend execution of the selected read thread, if the notification of a recording problem is received.

10. An information writing/reading method comprising:
a thread scheduling operation comprising controlling a sequence of execution for a plurality of threads,
a thread execution operation comprising executing a write thread and a read thread,
a command issuance operation comprising issuing at least one of a write command and a read command corresponding to the write thread and the read thread;
an information writing/reading operation comprising writing and reading information by controlling a disk mechanism in accordance with the at least one of a write command and a read command;
an end time estimation operation comprising estimating an end time of execution of an issued write command;
a determination operation comprising determining whether or not the estimated end time of execution is greater than an end time designated by the issued write command; and
a reading suspension operation comprising temporarily suspending execution of at least one read thread among the plurality of threads it the determination operation determines that the estimated end time of execution of the issued write command is greater than the end time designated by the issued write command.

11. The information writing/reading method according to claim 10, wherein the thread scheduling operation further comprises selecting a thread to be executed in accordance with a priority set for each of the plurality of threads, and
wherein the reading suspension operation further comprises lowering the priority of the read thread if the determination operation determines that the estimated end time of execution of the issued write command is greater than the end time designated by the issued write command.

12. The information writing/reading method according to claim 10, wherein the reading suspension operation further comprises assigning a quantum value to the read thread, wherein the quantum value indicates an executable time of the read thread, and
reducing the quantum value if the determination operation determines that the estimated end time of execution of the issued write command is greater than the end time designated by the issued write command.

13. The information writing/reading method according to claim 10, wherein the end time estimation operation further comprises estimating the end time of execution of the issued write command using a status of the disk mechanism.

14. A computer readable storage medium comprising instructions for enabling a computer to execute processes, comprising:
a thread scheduling process comprising controlling a sequence of execution for a plurality of threads;
a thread execution process comprising executing a write thread and a read thread in accordance with the sequence of execution;
a command issuance process comprising issuing at least one of a write command and a read command corresponding to the write and the read thread;
an information writing/reading process comprising writing and reading information by controlling a disk mechanism in accordance with the at least one of a write command and a read command;
an end time estimation process comprising calculating an estimated end time of execution of an issued write command;
a determination process comprising determining whether or not the estimated end time of execution calculated is greater than the end time designated by the issued write command; and
a reading suspension process comprising temporarily suspending execution of at least one read thread among the plurality of threads if the determination process determines that the estimated end time of execution of the issued write command is greater than the end time designated by the issued write command.

15. The information writing/reading program according to claim 14, wherein the reading suspension process further comprises lowering a priority of the read thread if the determination process determines that the estimated end time of execution of the issued write command is greater than the end time designated by the issued write command.

16. The information writing/reading program according to claim 14, wherein the reading suspension process further comprises reducing a quantum value assigned to the read thread, wherein the quantum value indicates an executable time of the read thread, if the determination process determines that the estimated end time of execution of the issued write command is greater than the end time designated by the issued write command.

17. The information writing/reading program according to claim 14, wherein the end time estimation process further comprises estimating the end time of execution of the issued write command using a status of the disk mechanism.
